(19) United States
(12) Patent Application Publication
(10) Pub. No.: US 2002/0140338 A1
(43) Pub. Date: Oct. 3, 2002

(54) Luminous low excitation voltage phosphor display structure deposition

(76) Inventor: Esther Sluzky, La Jolla, CA (US)

Correspondence Address: TELEGEN CORPORATION, 1840 GATEWAY DRIVE, SUITE 200, SAN MATEO, CA, 94404, US

(21) Appl. No.: 09/819,128

(22) Filed: Mar. 27, 2001

(51) Int. Cl. H01J 29/10

(52) U.S. Cl. 313/461; 313/483

(57) ABSTRACT

A low excitation voltage luminescent phosphor screen structure is presented applicable to vacuum visual displays and other devices. The phosphor grains utilized in the luminescent screen are strongly bonded with molecular colonies of conductive metal oxide, which allows for the deposited layers of these phosphors to be excited to luminosity at significantly lower voltages than were previously possible. Also presented are methods for production and increasing the quality and control of low cost mass production of such luminescent screens with no toxic gas emission.

### FIELD OF THE INVENTION

The invention relates generally to electronically excited phosphor screens for visual displays. More specifically, this invention includes novel phosphor structures that display visible emission with high luminance using low voltage electronic excitation and methods for preparing such low voltage electronically excited phosphor screens appropriate for use in high gain emissive displays (HGED), vacuum fluorescent displays (VFD), active matrix cathodoluminescent displays (AMCLD), field emission displays (FED), flat panel displays, other types of displays, electronic screens, indicators, and sensors.

### BACKGROUND OF THE INVENTION

Cathodoluminescent phosphor screens may be generally grouped into either “high excitation voltage” or “low excitation voltage” categories. High excitation voltage phosphor screens are activated by electronic systems with potentials of thousands of volts and low excitation voltage phosphor screens can be activated by electronic systems with potentials in the tens to hundreds of electron volts. Phosphors used in traditional cathode ray tubes or CRTs are high excitation voltage phosphors, activated by approximately 10 kilovolts or more. The high anode voltage used to activate high excitation voltage phosphor screens in CRTs causes secondary electron emission in the phosphor matrix, thereby preventing a buildup of negative charge on the phosphors. In contrast, low excitation voltage phosphor screens are used in conditions where secondary electron emission is rare to nonexistent.

To enable activation of low excitation voltage phosphor screens under low anode voltage conditions, different treatments have traditionally been applied in which phosphors are typically deposited on an electrically conductive surface, such as indium-tin oxide (ITO). Additionally, the phosphors are often mixed with similar or slightly smaller sized particles of a conductive metal, and interspersed in discrete chunks among the phosphor grains to reduce the resistance of the normally dielectric phosphor screen layer.

For example, in U.S. Pat. No. 5,055,227 Yoneshima et al. present a method of coating phosphor grains with discrete microparticles of indium oxide (In₂O₃). A schematic of such a coated phosphor grain is shown in FIG. 1. In this prior art instance, the phosphor grain (51) has been treated with a conductive material and discrete particles of this conductor (52) are attached to the phosphor. In U.S. Pat. Nos. 4,081,398 and 4,208,613, Hase et al. present the method depicted in FIG. 2, where the phosphor grains (54) are co-deposited with conductive indium oxide particles (53) onto a conductive coating (55) on a nonconductive substrate (56).

These methods, while reducing the buildup of charge on the phosphor screen surface and thus reducing the threshold potential for luminescent operation, still have major drawbacks. First, the phosphors either must be prior treated with a conductive material, requiring additional fabrication steps, or they must be co-deposited with substantial quantities (10-90% of the deposited material) of the non-luminescent metallic conductive material, which proportionately decreases the potential luminescent output by blocking substantial area of each luminous phosphor grain from view in the display. Any non-luminescent material in the matrix will inherently reduce the potential brightness and sharpness of the final luminescent screen by absorbing, reflecting or dispersing the emitted light, thereby diminishing the amount of light that can be delivered as useful display luminance in direction of the viewer. Further, these methods of adding conductive material to phosphor have only worked to lower the operating voltages of the phosphors to the tens or hundreds of volts, and have not been adequate to produce thresholds of sufficient luminescence while operating in a display at less than ten of volts.

One of the standard prior art methods of evenly depositing phosphors onto a screen is electrophoretic deposition. In that prior art process as depicted in FIG. 3, the phosphor particles are suspended in a typically alcoholic solution containing a metal salt, typically magnesium nitrate. In that solution, some of the metal ions adsorb onto the surface of the individual phosphor grains, giving these grains a net positive charge. Phosphor grain (57) is suspended in a metal salt solution containing alcohol. Metal ions (58) in solution can interact with the phosphor grains, and some of the metal ions are adsorbed onto the surface of the phosphor particle, producing a charged phosphor particle (59).

After the phosphor particles have interacted with the salt solution for some period of time, the suspension of phosphor particles is used to electrophoretically deposit the phosphor grains onto the surface of the substrate, as depicted in FIG. 4. Inside the plating vessel (60), an electrolyte salt solution (61) contains metal ions (58) and charged phosphor particles (59). Into this solution are placed a solid or mesh electrode (62) and the screen to be plated (63). When a potential is applied via power supply (64), the electrode (62) is given a positive potential, and the substrate (63) connected to the negative potential. As soon as these potentials are applied, the charged particles, most notably the metal ions (58) and the phosphor particles (59) migrate towards the oppositely charged electrodes. This migration under applied fields is known as electrophoresis.

When manufacturing a low voltage luminescent screen, the presence of water can be a distinct problem. First of all, some phosphors are very water sensitive and their luminosity is degraded or destroyed by the presence of water. Also, during the electrophoretic deposition of phosphors, if the water content of the plating solution is too high, excess water reduction can occur. This reduction of water causes the generation of significantly large hydrogen bubbles, which in turn perforate the phosphor layer permanently causing pinholes or void tracks in the screen, and weakening the adhesion of the phosphor particles to the surface that they are deposited upon.

Further, once the luminescent screen has been formed, and is within a vacuum envelope, water can have other deleterious effects on the performance of the screens and the vacuum displays in which they operate. For example: water causes cold and hot cathode electron emitters to degrade, thereby significantly shortening the lifetime of the display device. Even extremely small amounts of water inside the narrow gap of miniature flat panel vacuum envelopes can cause undesired luminosity variance effects.

In order to remove the water that has been incorporated during the deposition of the phosphors, the deposited screen is baked at high temperatures. Some of the components of the luminescent screen may in fact be damaged or degraded by this baking process. In general, by minimizing the amount of water that the luminescent screen is exposed to during the manufacturing process, one has an easier time removing whatever water was incorporated into the phosphor matrix, thus simplifying the manufacturing of such luminescent screens.

Prior art attempts to form low voltage phosphors through electrophoresis have often resulted in undesirable levels of water being introduced into the screen. For example, Lu et al., U.S. Pat. No. 5,635,048, teach forming a low voltage phosphor screen using various metal-chlorides. Although their process does not require addition of water, it involves aqueous substances and results in the introduction of water into the manufactured screen, with the attendant problems with the manufactured screens. Furthermore, the electrophoresis taught by Lu et al. process results in outgassing of chlorine gas, a toxic gas.

Phosphor screen manufacturing processes are subject to undesired variation during the mass production of screens. Control of the consistency and homogeneity of the preparations has been a continual area of concern and requires close tolerances in the processes to achieve acceptable quality assurance levels. The continuous flow of production lines require close monitoring of the tanks for phosphor suspension and content over many cycles of use by many screens passing through the same zones. Smooth distribution of luminosity producing material across the entire area of each screen has required arcane techniques to achieve consistency as re-used mixtures are prone to settling or differentials in dispersement active content as units pass through the tanks. The low viscosity of the Liu et al. deposition bath results in the suspended material is prone to settling, which makes production more difficult.

The bonding material used to adhere phosphor and other materials applied to luminous screens has in some cases been prone to breakage of the bonds under vibration and shock. Weakly bonded screens are prone to deterioration with age and may not be applied to certain rugged environments, mobile, or portable applications. The adverse effects of the breakage of the bonds of the screen material include voids or areas of lower luminosity, lost pixels, or rendering of the display unusable. Use of insulative bonding or cementing material requires higher excitation voltages to be used.

Multiple steps for preparation of the luminosity producing material of the screen prior to the actual deposition of the material increases the probability of process variation, degradation of the materials, and resulting failure of to achieve quality assurance levels.

### SUMMARY OF THE INVENTION

The present invention relates generally to a method for producing low voltage excitation electroluminescent and cathodoluminescent screens, appropriate for use in a wide variety of low voltage electroluminescent and cathodoluminescent display devices, including, but not limited to: field emission displays (FED), vacuum fluorescent displays (VFD), high gain emissive displays (HGED), and active matrix cathodoluminescent displays (AMCLD).

The primary object of this invention is a phosphor screen with lower voltage excitation emissive thresholds utilizing many types and hues of phosphors combined with more cost effective mass production of the phosphor screen.

Another object of the invention is a phosphor screen with a durable structure in which the screen's luminous layers are bonded mechanically and electronically to the conductive foundation layer while simultaneously minimizing the blockage of light emission from the excited phosphors.

Yet another object of the invention is to cost effectively mass produce a phosphor screen without additional difficult steps of separately treating or prior modification of the phosphors in the manufacturing process, and without the incorporation of water or large quantities of non-luminescent material into the phosphor matrix. Further, it is to stabilize and control the production processes of the phosphor screen throughout the cycling of many units, thereby increasing the quality assurance level.

Still another object of the invention is to produce a phosphor screen using a process that is low in toxic gas emission, thereby improving environmental safety surrounding the production process.

Another object of the invention is to produce a phosphor screen for visual displays with extended lifetime when used in low voltage electronic vacuum flat panel visual displays.

Still yet another object of the invention is a unique phosphor screen structure formation that is inherently and selectively conductive to the flow of electrons in specific paths through the phosphor matrix.

In the present invention, a phosphor screen is presented for use within vacuum electronic visual displays wherein the phosphors are bonded to a special indium oxide structure, which enables the efficient conduction of electrons into and out of the phosphor matrix and lowers the resistance of the phosphor layer as a whole. The indium oxide structure also provides electronic contact between adjacent phosphor grains, between phosphor grains and the foundation surface, and between the electronic field that excites the phosphor screen to luminosity in the visual display. Furthermore, the indium oxide structure provides electronic contact and the conductivity between different areas of the phosphor matrix of the same phosphor grain.

By reducing the resistance of the phosphor layer, and utilizing this special indium oxide structure, the buildup of so-called surface charges on the phosphors is significantly reduced, and the phosphor screen is luminescent at lower excitation voltages. The present invention luminescent screen operates within an electronic vacuum visual display with lower operating voltages than were previously available. By operating these display screens at lower voltages, less heat is generated, high voltage driving circuits are eliminated, and the lifetime of the phosphor screen and display as a whole is increased.

In the present invention, the surface structure of the grains of luminescent phosphor material is specially bonded to extremely thin and specially deposited areas or patches of conductive indium oxide. These conductive indium oxide areas are grown on the surface irregularities, micro-fractures, and protrusions of the roughly shaped phosphor grains as intricately porous structured colonies made from molecular indium oxide in special electrochemical processes. Additionally, the junctions between colonies of indium oxide surface structures serve as strong mechanical bonds, permanently holding the phosphor material on the surface to which it has been deposited and holding the adjacent phosphor grains together.

In another embodiment of the present invention, a method for building and depositing the phosphor screen layer structure onto a conductive surface is presented using indium nitrate as the charging compound for the electrophoretic deposition of phosphor layers onto conductive surfaces, followed by heat-treating.

The phosphor structures of the present invention and the associated phosphor plated luminescent screens are well suited to use in low-voltage electron impact devices such as HGED, field emission displays (FED) and vacuum fluorescent displays (VFD), where lower operating voltages greatly broaden the scope of use. Further, in an embodiment of the present invention, the phosphor screen structure is grown, directly deposited and cemented onto a glass panel coated with a transparent indium tin oxide conductor, the phosphor screen structures are, as prepared, ready to be used in a flat panel display. FIGS. 5 and 6 show two possible arrangements of such panels. In FIG. 5, a glass, or other nonconductive substrate (30) is covered with small pads or pixels of conductive material, such as aluminum, silver, gold, tin, ITO, or any other suitable conductor. FIG. 6 shows a similar design, but in this case, the conductor (32) has been laid down in lines or strips on the insulating substrate (30). The conductive pads are selectively built up forming the present invention phosphor layer structure. Electronic connection to the various base conductive pixels or strips provides biasing paths for electronic flow both for the structure manufacture and in the end use of the screen within a vacuum display. Selective biasing of the same base conductive pixels or strips through the phosphor screen structure yields viewable luminosity.

In a present method for creating these phosphor screens, several steps are involved. First, a phosphor is chosen with the desired luminescent characteristics, for example, a ZnS:Ag phosphor, which emits in the blue range of the spectrum. The phosphor is ground to the proper size, shape and desired surface texture using a ball mill and the phosphor grains to be used are chosen by carefully culling phosphor material that is not within the parameters for optimum size, shape and surface. The phosphor grains have a rough surface texture, resulting from collisions in the ball mill, and fracturing of the crystalline matrixes. A high degree of surface roughness is advantageous for maximization of the surface area and development of growth of the phosphor screen structure. The phosphor is then suspended in a solution containing indium ions (In³⁺), such as might be obtained from indium nitrate. No water is used in the solution. In an embodiment of the present invention the deposited phosphor screen structure is heat treated to complete the conversion of the indium compounds present to indium oxide.

### BRIEF DESCRIPTION OF THE DRAWINGS

FIG. 1 shows one embodiment of the prior art: a phosphor grain coated with conductive microparticles.

FIG. 2 shows another embodiment of the prior art: phosphor grains which have been co-deposited with conductive particles onto a conductive surface.

FIG. 3 shows a typical phosphor grain becoming charged by adsorption of metal ions to its surface.

FIG. 4 shows a schematic diagram of the electrophoresis apparatus.

FIG. 5 shows a schematic view representative of phosphor screens in pixelized form in accordance with the present invention and useful for viewable electronic displays.

FIG. 6 shows a schematic view representative of phosphor screen structures on conductive strips or lines form in accordance with the present invention on a nonconductive substrate such as a glass, ceramic, or non-reactive surface and useful for viewable electronic displays.

FIG. 7 shows, in cross-sectional schematic view, a phosphor screen structure with deposited mass layer of suspended phosphor.

FIGS. 8A-8C shows a series of schematic views of a phosphor grain in the process of forming colonies of indium nitrate upon its surface, in accordance with the present invention.

FIG. 9 shows a schematic view representative of the vectors of movement of molecular indium and suspended phosphor in a charged solution in accordance with the present invention.

FIG. 10 shows a schematic view representative of phosphor, conductive, and insulative layers in accordance with the present invention.

FIG. 11 shows, a schematic representational view of phosphor and colonized indium structures in accordance with the present invention.

FIG. 12 shows an illustrative cross section of a completed phosphor screen structure according to the present invention.

FIGS. 13A-13C depict phases for manufacture of phosphor screens according to the present invention.

FIGS. 14A-14C show depict phases for manufacture of phosphor screens such as those found in the prior art that lack well-controlled homogeneity and uniformity.

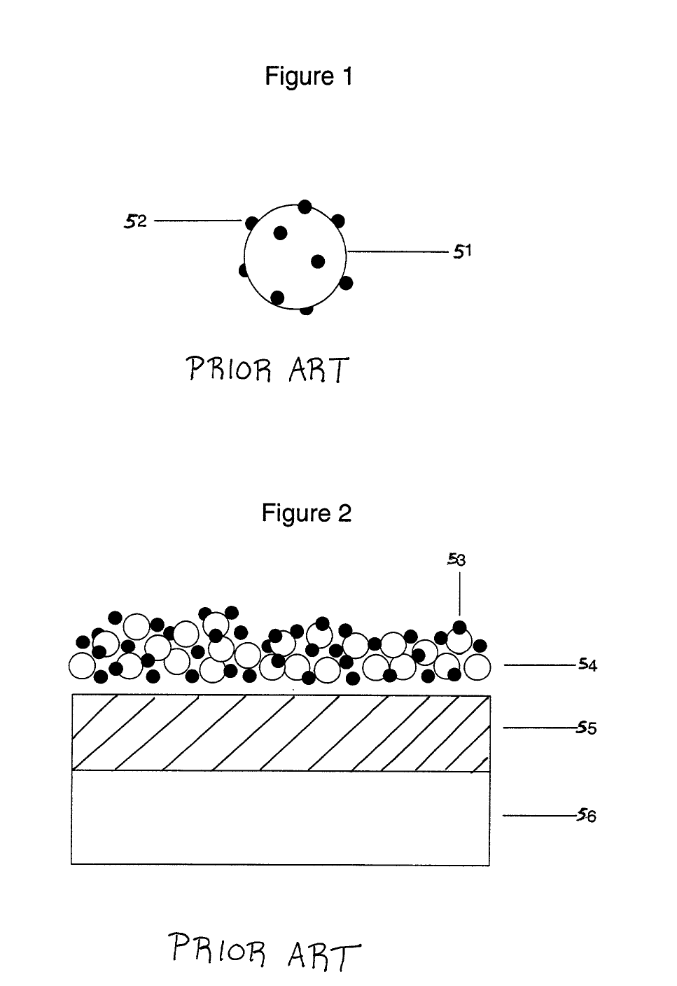

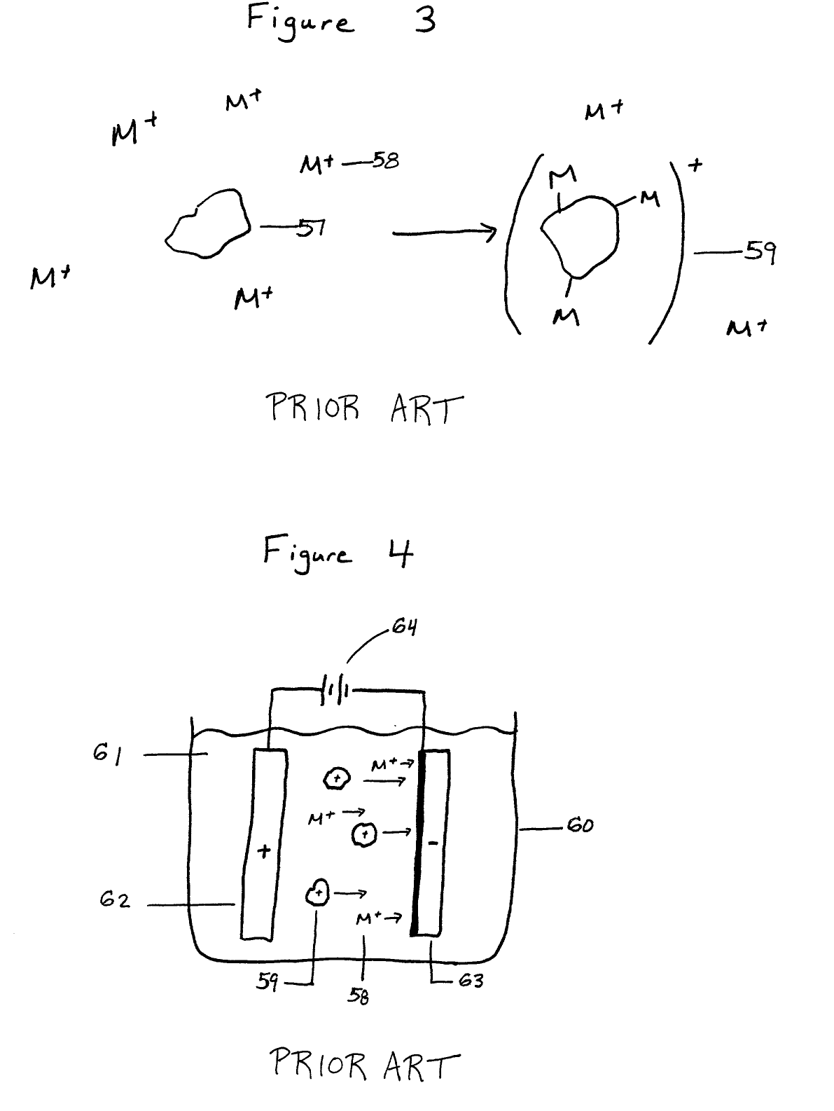

### DESCRIPTION OF THE INVENTION

The method of producing the low excitation voltage phosphor screen structure according to the present invention may be utilized in a wide variety of ways, the general approach of these being broadly outlined in the following description, the general and specific examples following thereafter, and the illustrative figures.

The phosphor to be used must first be suspended in a non-aqueous solution containing a source of In³⁺ ions. In one embodiment this is a solution of 1 to 30 grams indium nitrate per liter of solution (3 g/L), where the solvent is isopropyl alcohol, preferably anhydrous, which contains 5-10 percent glycerol by volume (7.5% b.v.). It has been discovered that indium nitrate does not dissolve in pure isopropyl alcohol. The prior art, such as Lu et al., teaches that water was needed to dissolve indium nitrate in other types of processes. Since an objective of the present invention is to produce a phosphor screen without adding water in the process, it was determined that no water would be added to dissolve the indium nitrate.

Using the addition of glycerol to the mixture in this embodiment of the present invention solves the problem of dissolving the indium nitrate. With the addition of glycerol, the indium nitrate becomes completely dissolved. Also, the glycerol develops the proper viscosity to the mixture to maintain prolonged homogeneous suspension of the phosphor grains within the deposition vessel over many production cycles of phosphor screen deposition.

To initially suspend the phosphor in this mixture, agitation, shaking, sonicating or rolling in a ball mill may be used. Other compounds may also be present in this mixture, for example Tin Nitrate (SnN) in concentrations of 1-10 grams per liter has been used to improve plating conditions in some instances. Solid indium oxide, in quantities of 0-50% of the phosphor mass have also been traditionally used to prepare and deposit phosphors.

Once the phosphor slurry has been made, the slurry is diluted to the desired final concentration, a 10 to 20-fold dilution, with 12.5:1 dilution being the norm. The diluted mixture is then agitated (sonicated) to re-suspend the phosphor (and indium oxide) particles. No additional water is added to the plating solution. At this point, an assembly is lowered into the phosphor mixture consisting of a non-conductive substrate with a conductive surface coating, along with a solid or mesh electrode, which is held parallel to and 1 to 10 centimeters away from the conductive surface. A potential of 10 to 100 Volts is applied between the connection to conductive surface upon which the phosphor screen is to be bonded, and the connection to the electrode, using the conductive surface as the cathode and the mesh or solid electrode as the anode. The potential is applied for a period of 20 seconds to 5 minutes. This entire process is performed in the absence of water.

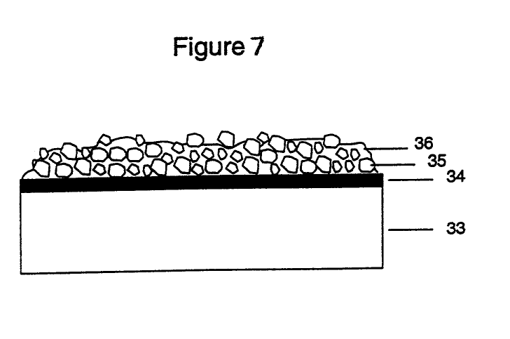

After the phosphor screen structure has been grown onto the conductive surface, the phosphor screen precursor has the basic structure shown in FIG. 7. The newly deposited phosphor is rinsed to remove excess electrolyte. In one embodiment, two rinses are performed, first a rinse in IPA, then one in acetone. After rinsing, the coated material is dried. the assembly is removed from the phosphor suspension. A substrate (33) is covered with a thin layer of conductor (34), the conductor in turn is coated by the layer of the phosphor particles (35), which are imbedded in, and partially-to-completely covered with a layer of indium hydroxide and alkoxide salts (36). Substrate 33 may be composed of an insulator, a semi-conductor or other material appropriate to the present invention.

In order to remove all remaining solvent from the phosphor and ensure complete conversion of the indium salts to indium oxide, the phosphor layer is heat-treated. In one embodiment, this is performed by baking the phosphor-coated substrate at 350° C. to 500° C. (425° C.) for 15 minutes to 2 hours (30 minutes).

During this drying and baking, several processes occur that make a noticeable difference in the appearance and makeup of the phosphor layer. As the newly deposited screen emerges from the plating bath, the phosphor matrix is made up of phosphor particles, indium hydroxide and indium alkoxides. The matrix is also saturated with solvent, which causes it to swell. As the solvent evaporates, this swelling diminishes, and the phosphor layer appears to have less bulk.

Then, when the deposited screen is heat treated, the chemical makeup of the matrix changes. As the indium hydroxide and indium alkoxides, which adhere the phosphors to the surface, heat up they begin to decompose. The indium compounds will release a mixture of alcohols and ethers, becoming indium oxide. As this outgassing occurs, the mass and bulk of the indium-based adhesive diminishes.

This outgassing can be contrasted with the outgassing of chlorine gas as taught by Lu, et al. One of the advantages of the present invention is the production of less hazardous and more safely disposed by-products.

Thus, the coverage or “skin” of indium compounds should shrink during the drying and heat-treating processes. Because of the sensitivity that the screen components and phosphors have to water, all use of water in any of the manufacturing steps is to be rigorously avoided.

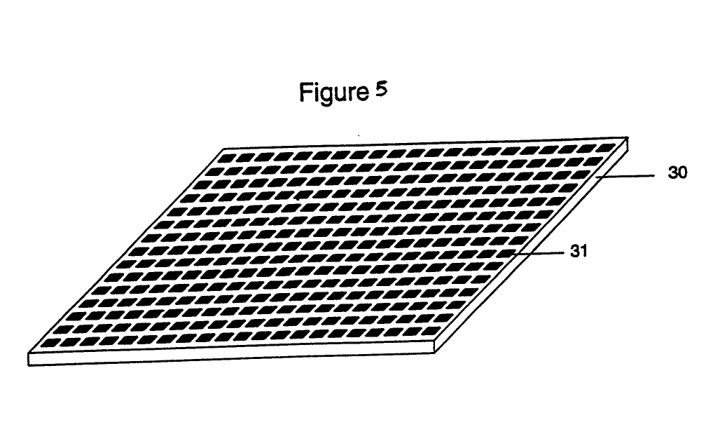

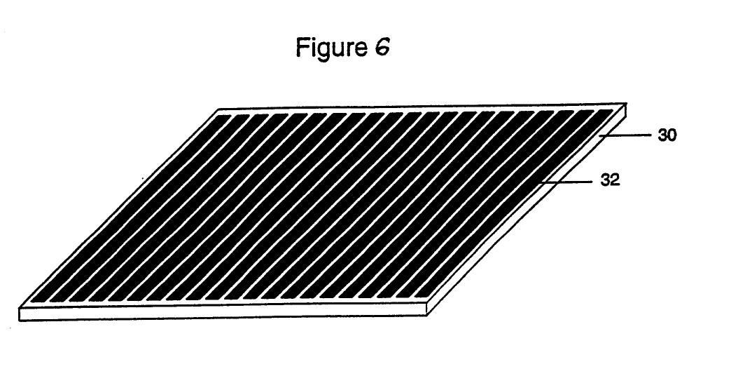

Luminescent screens prepared according to the present invention have the general form shown in FIG. 5. A glass, or other insulating substrate (33) is coated with a layer of conductor (34). This conductor, whether it is a metal, (such as aluminum, copper, tin, silver or gold) or a conductive metal oxide (such as indium oxide, tin oxide or ITO) typically has a thickness of between 200 and 2000 angstroms. On top of this conductor is a layer of phosphor granules (35), which are imbedded in and partially coated by a layer of conductive indium oxide (36). The phosphor layer has a typical thickness of between five and fifteen microns, which typically corresponds to a thickness of between one and four phosphor particles, depending upon the particle size distribution. Other layer thicknesses are appropriate for different size phosphor grains depending upon the required pixel or line size of the display. Smaller size phosphor grains are also utilized in lower ranges of layer thicknesses below 5 microns. Larger size phosphor grains are also utilized in higher ranges of layer thicknesses above 15 microns. An advantageous configuration is from two to three phosphor grain layers deep to maximize electron efficiency while minimizing light deflection or re-absorption by other phosphor particles, which due to their opaqueness, can also block the view of another eclipsed emitting phosphor structure element or phosphor grain.

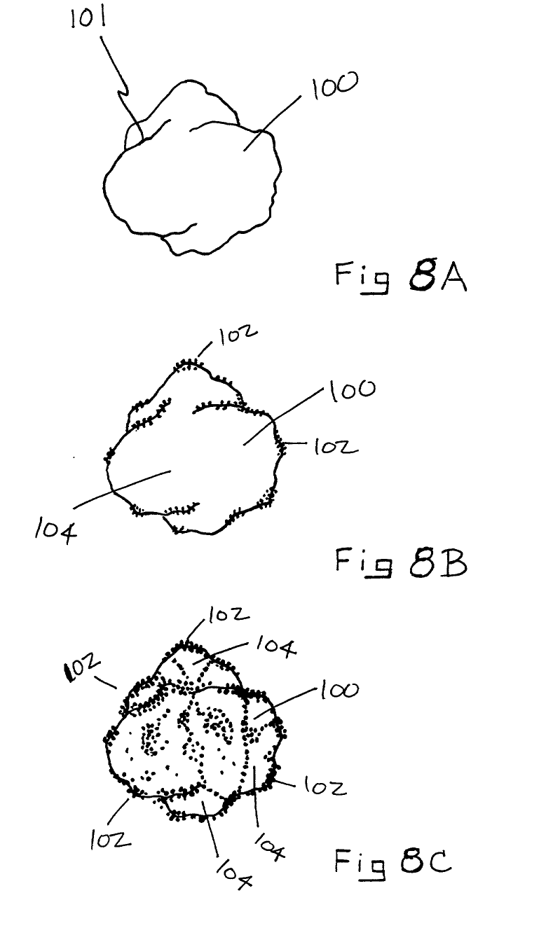

The operation of a luminescent screen according to the present invention may be understood in light of an illustrative example of how such a screen may be formed, as illustrated in FIGS. 8-11. An exemplary phosphor grain (100) is shown in FIG. 8A, which is typical of the plurality of phosphor grains that form the phosphor screen. For clarity, singular phosphor grains and small groups of phosphor grains are shown in these Figures so as to more clearly describe in detail, although the same description is applied to the plurality of phosphor grains that form the rest of the phosphor screen structure.

The phosphor grain (100) of FIG. 8A is shown in prepared form as an irregularly shaped globular nugget composed of a phosphor crystalline structure. The phosphor crystalline structure has been broken by fracturing due to collisions during ball mill preparation, yielding a surface with different parts of the phosphor crystalline matrix exposed to the surface, with microfractures, surface irregularities, protrusions, pits, and phosphor matrix broken ends. The surface of phosphor grain (100) has been prepared to be of very rough texture, to maximize the surface area, and to expose broken bonds of phosphor matrix to the outside surface.

The size of the grain used in preparing the luminescent screen is selected by determining the depth of the phosphor screen layer required by the display in which the phosphor screen is used. The size of the phosphor grain (100) is optimized to achieve optimum luminosity and homogeneity according to the pixel size or dot pitch. Uniform range of phosphor sizes are prepared which are optimized in this embodiment to the values of 1:1 to 1:4 ratio of phosphor grain diameter to layer thickness.

In addition to these phosphor grains (100), other phosphor grains with ratios of higher than 1:4 ratio of phosphor grain diameter to layer thickness may be included within this embodiment of the present invention. These smaller phosphor grains are desirably included to eliminate wasted phosphor material in the process, and the average or mean phosphor diameter to layer thickness ratio is then adjusted to smaller ratios, according to the specific display screen pixel size and dot pitch requirements, and to optimize overall luminance in the field of view.

The process of preparation of an individual phosphor grain according to the present invention is shown as the series of FIGS. 8A-8C. Phosphor grain (100) is immersed and suspended in the prepared solution containing indium nitrate in solution, as in the method described above and illustrated in FIG. 4. Phosphor grains (100) and solution are agitated, which causes molecules of indium nitrate to be trapped by, embedded, and cling to the microfractures, surface irregularities, protrusions, pits, and phosphor matrix broken ends of phosphor grain (100). The molecules of indium nitrate in solution adhere to the surface and tend to be trapped more as the suspension is agitated and with the passage of time, as illustrated by the series of FIGS. 8A-8C. The molecules of indium nitrate, through controlled turbulent chaotic action fluid flow, and phosphor grain chaotic geometric surface irregularity features (101), form broad distribution patterns of groupings or areas of concentration in patches or colonies (102) in the surface irregularities (101), and areas of little or no molecular indium (104).

Due to the proper viscosity of mixture utilized in preparation of the structure and surface tension of the fluid as evaporation is in progress during drying and or bake-out phases, tendrils of concentrated solution of molecular indium form between the phosphor grains (100) and the foundation surface. These tendrils form concentrated interconnections for electronic flow in exactly the proper locations to enhance excitation of the phosphor matrix in the resultant luminous screen in final use. The resultant structure forms a network of variable density molecular indium colonies. The carefully controlled proper formation of variable density molecular indium colonies is advantageous to develop a low excitation voltage phosphor screen structure. The process time allowed for the agitation and immersion is limited so as to prevent colonies (102) of molecular indium nitrate from completely growing and covering the entire surface of the phosphor grain. Phosphor grain (100) is now ready for voltage to be applied across the suspension.

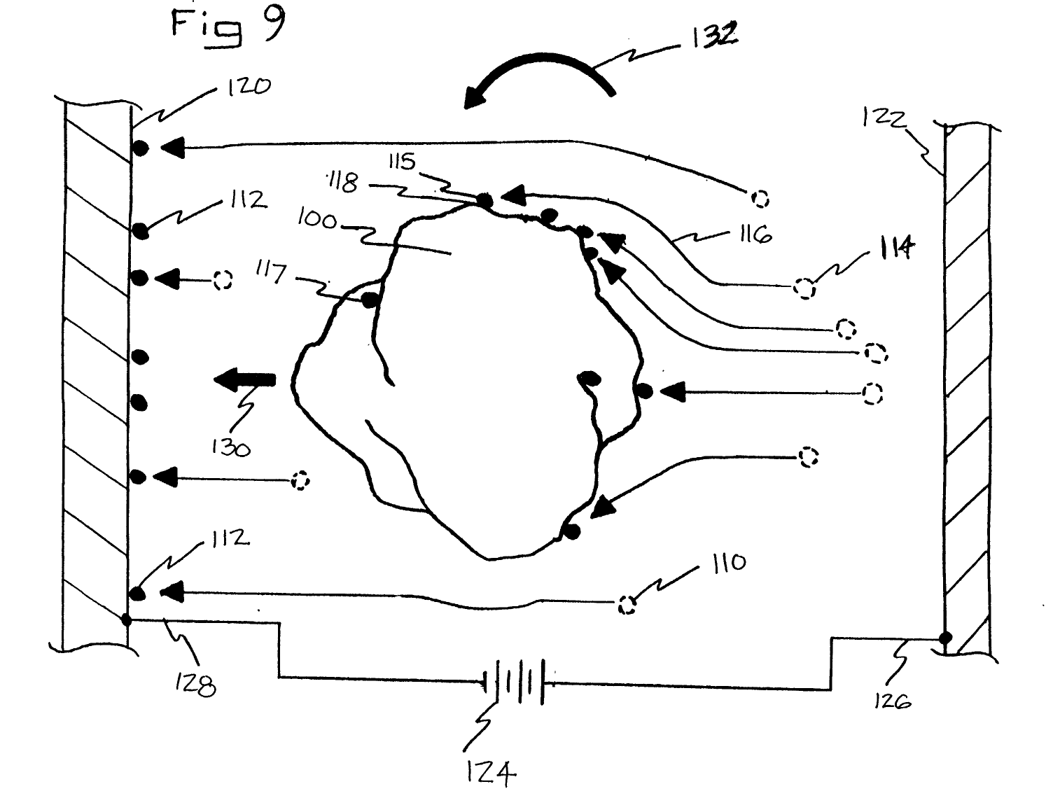

In schematic representation view FIG. 9, cathode (120) is shown which is also the conductive metallic foundation surface upon which the phosphor screen structure is formed. As voltage (124) is applied between cathode (120) and anode (122), it causes a voltage differential range across the suspension. Molecules (110) of indium nitrate which are in close proximity to cathode (120) are attracted to cathode (120) and are more highly mobile due to being in solution, than suspended the phosphor grain (100). The first molecules of indium nitrate (110) are electroplated directly and immediately to cathode (120). This electroplating forms a very strong permanent interlocking bond between indium nitrate molecules (112) and the surface of cathode (120). In this manner many indium nitrate molecules are built up rapidly to form a base layer of indium nitrate upon cathode (120).

Phosphor grain (100) in suspension is within general proximity to the surface of cathode (120). Highly mobile indium nitrate molecule (114) is attracted toward cathode (120) and moves along a path (116) according to both electronic attraction vector (130) and fluid flow vector (132) toward the direction of cathode (120). However, it is prevented from reaching cathode (120) by the position of phosphor grain (100) and rough protrusion (118) on surface of phosphor grain (100), where the molecule becomes lodged (115) and bonded to phosphor grain (100). Other molecules of indium nitrate are present from previous process steps that are in colonies (117) on the surface irregularities, represented by a dot in the schematic view of FIG. 9.

Slight differentials in voltage and structural differences along the surface of phosphor grain (100) between indium nitrate colonies (102) cause indium nitrate molecules to migrate and bond with the colonies (102) of indium nitrate that are previously bonded with the surface irregularities of phosphor grain (100).

However, phosphor grain (100) is not static, but is in chaotic motion within the suspension. Hence, as one side of the phosphor takes a greater quantity of micro-colonies of indium nitrate, due to chaotic effects, the phosphor grain tumbles and turns according to fluid movement (132) and electronic attraction movement vector (130). Phosphor grain (100) moves in the direction of the surface of cathode (120) propelled by the chaotic fluid motion along with attraction to the colonies (102) of indium nitrate which have been grown in and on the surface irregularities of phosphor grain (100). Phosphor grain (100) then firmly bonds to cathode (120) through the molecular bonding of the porous colonies (102) of indium molecules and gripping friction of the indium colonies (102) to the surface roughness protrusions (118) and fractures of phosphor grain (100).

These colonies (102) of indium in many areas of phosphor grain (100) are in close electronic contact with the broken ends of the phosphor matrix, which also are some of the optimal points of contact for electronic excitation of phosphor grain (100). Thus, the colonies of indium deliver direct electronic excitation to each phosphor grain centers of luminance at high efficiency, with little loss in resistance, when the colonies (102) of indium on phosphor grain (100) are in contact with other electronic conductors connected directly or indirectly to the base foundation conductor, as well as the electronic field within the vacuum of the display from the anode to the cathode poles and nodes. Adjacent similar phosphor grains (100) with their own similar indium colonies (102) become part of the same electronic circuit as the connection between the indium colonies (102) grows and bonds together in the electroplating process or due to conductive contact by position.

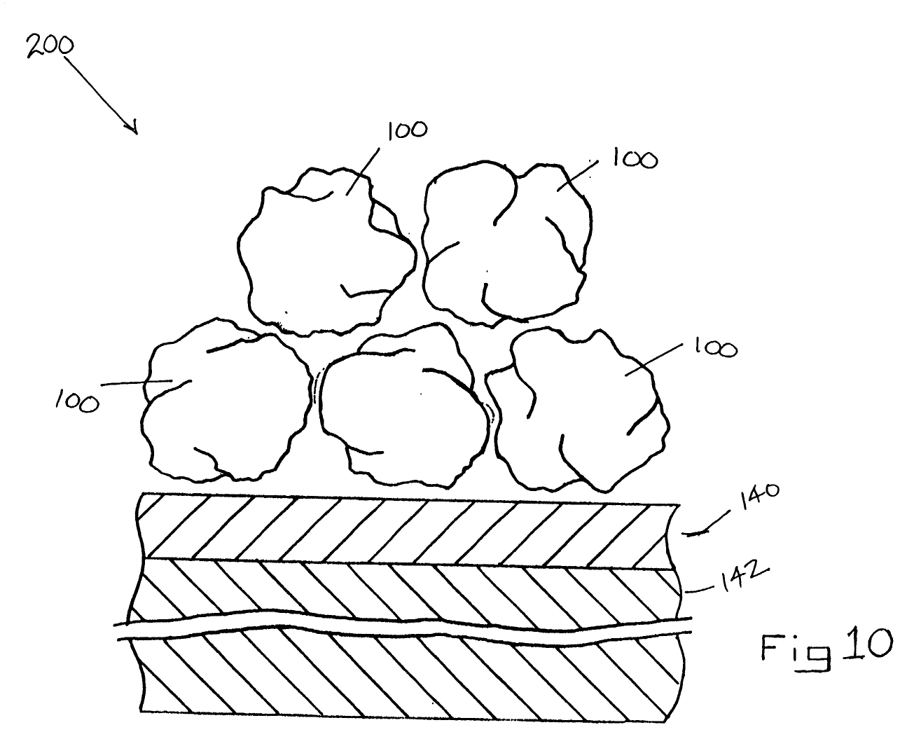

In the phosphor screen cross section drawing FIG. 10, the phosphor grains (100) adjacent to conductive surface (140) and adjacent substrate (142) are shown as an example of a phosphor screen structure (200) which has been built up as an embodiment according to the present invention described. For clarity, FIG. 10 shows a layer thickness of two phosphor grains (100) with exaggerated gaps (119) between the phosphor grains (100). Also, for the purpose of clarification of this description and drawing, no structured indium colonies are shown in FIG. 10, while those are then illustrated for the same section in FIG. 11.

In the phosphor screen cross section schematic drawing FIG. 11, the phosphor grains (100) adjacent to conductive surface (140) and adjacent substrate (142) are shown as an example of a phosphor screen which has been built up as an embodiment according to the present invention. For clarity, FIG. 11 shows a layer thickness of two phosphor grains (100) with exaggerated gaps (119) between the phosphor grains (100). Also, for the purpose of clarification of this description and drawing, indium colonies (102) are shown schematically represented as groups of dots in this view. In actual phosphor grains (100), these colonies (102) form a rash-like pattern (103) on the surface of phosphor grain (100).

The size of actual indium molecules is much smaller than can be shown at the scale of the figure drawings. Therefore, central areas of higher concentrations of the colonies of indium are represented by dots in the figures. The dot density in the figures should be considered as representative of relative differentials in concentration density of molecular indium. The dispersion of molecular indium colonies in the structure in areas of relatively low concentration provides windows for the luminous photons emanating from the phosphor matrix to be useful for illumination of the screen and viewing. The same areas of the phosphor matrix within the windows of low concentration of colonial indium are also those which, when the structure is excited by electrons, provide the most luminosity due to electrons being channeled through the interior of the matrix.

Furthermore, FIG. 11 illustrates a pattern of indium nitrate molecules (112) formed on conductive surface (140). As described above, these indium nitrate molecules (112) form a strong conductive bond to phosphor grains (100), yielding an extremely efficient phosphor structure capable of unusually high luminosity for very low applied voltages.

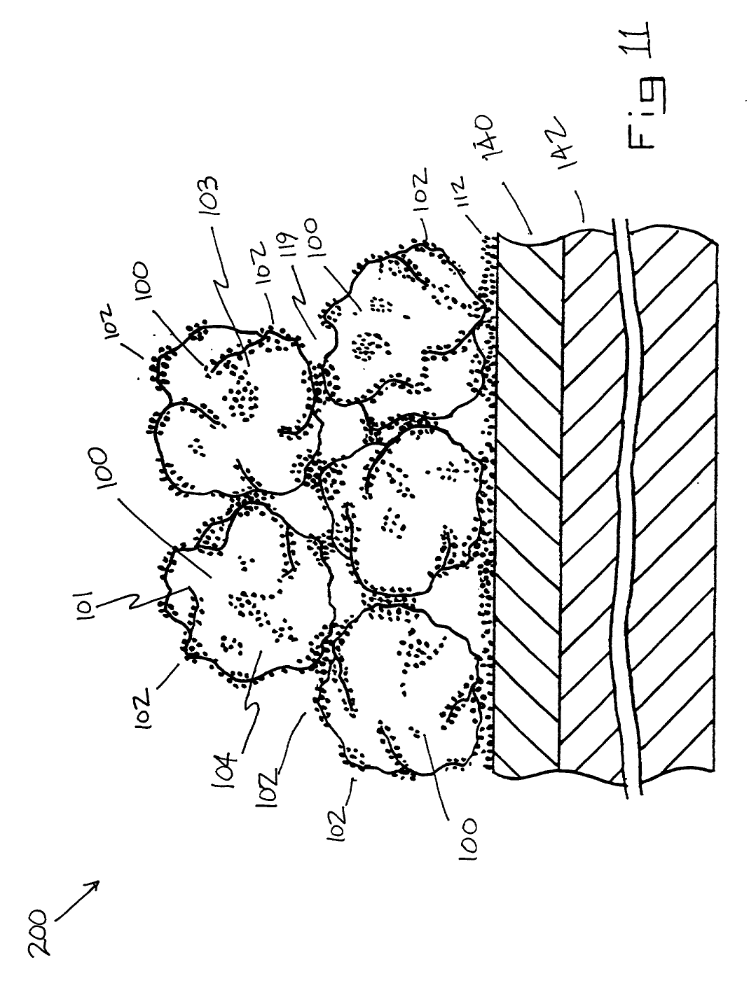

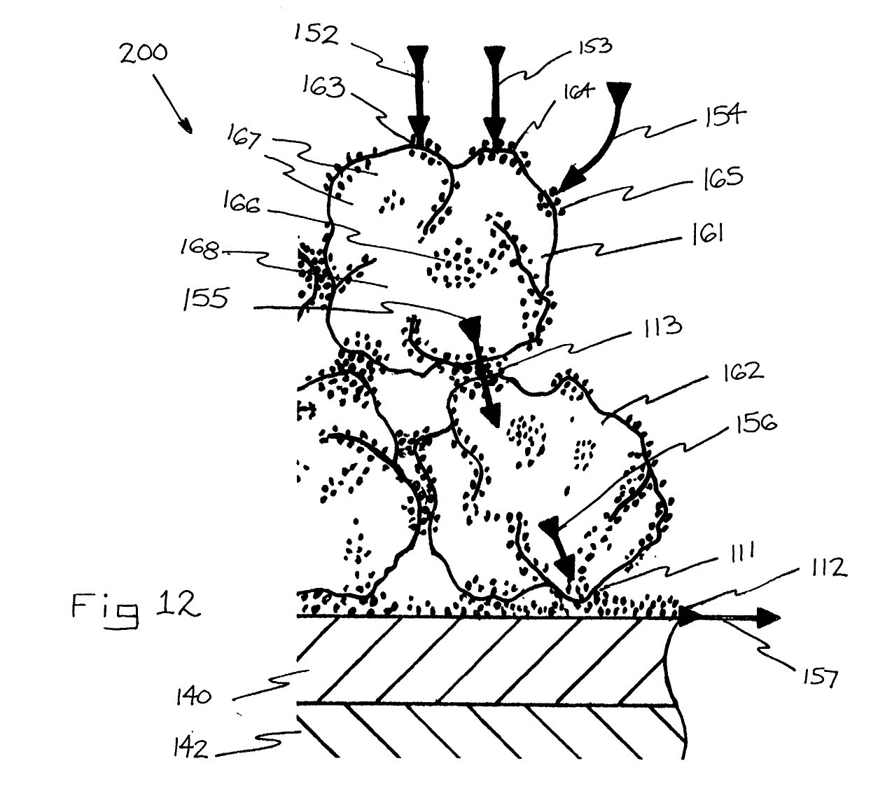

FIG. 12 is an illustrative diagram that represents a cross section of a completed working phosphor screen structure (200) and electronic flow diagram according to the present invention, in which the structure is approximately 2 phosphor grain diameters in thickness and within a vacuum display environment. For clarity, two phosphor grains (100) specifically denoted as top phosphor grain (161) and bottom phosphor grain (162) are shown which are situated abutting other phosphor grains (100) and the foundational conductive base surface (140) and held in place by colonies of molecularly grown indium oxide (111) and molecular indium colony pads (113) between phosphor grains. Substrate (142) and conductive base (140) form the foundation of the screen structure, with a plated foundation layer of indium oxide (112) adhering and connecting electronically to the conductive base (140) which is in turn connected to an electronic circuit functionally as an anode biased positively for control of the electron excitation of the screen in the area illustrated.

Electronic field flow vector illustrated with arrow (152) diagrammatically shows the direction of the electron field flow from a negatively biased cathode towards and into the nearest points of the phosphor screen structure which are in this case a localized colony of indium (163) on the surface of the topmost grain of phosphor (161). A similar vector arrow (153) and a similar colony of indium (164) provides another path for electron flow. Another similar vector arrow (154) and colony of indium(165) illustrates the flow of electron field from the biased cathode at a different angle and localized field space. Due to the close bond between the localized densities of conductive indium oxide molecular colonies (163) (166) (113) and phosphor grain (161) and the adjacent localized areas of less density (167) of conductive indium oxide molecular colonies, the flow of electronic field through phosphor grain (161) is channeled and provided a portal into the phosphor matrix and centers of luminance (168).

The electron field seeks paths of least resistance toward the positively biased anode. Vector arrow (155) diagrammatically illustrates the flow of electron field out of the phosphor matrix of phosphor grain (161) through localized conductive patch of indium oxide colony (113), which is bonding the abutting phosphor grain (162) to phosphor grain (161). Vector arrow (156) diagrammatically illustrates the flow of electron field through the phosphor matrix of phosphor grain (162) toward localized conductive patch of indium oxide colony (111) which is bonding the indium oxide bedding layer (112) abutting base conductive layer anode (140) to phosphor grain (162). Vector arrow (157) diagrammatically illustrates the flow of electron field through the base conductive layer anode toward the biasing control circuit.

As illustrated in this figure, the flow of electrons is directed through the phosphor matrix and is caused by differentials in potential between areas of more highly concentrated densities of indium oxide colonies. The electron flow is channeled into and out of the phosphor matrix in this structure when bias is applied, due to the electronic bonds provided by specific areas of the surface being made more conductive by the denser indium oxide colonies, while other areas of the surface are less conductive by less dense or no indium oxide colonies. Since the internal crystalline phosphor matrix provides a more conducive path for the electron flow than the surrounding vacuum, and the vector path lengths are minimized by growing a plurality of indium colonies on the surface of the phosphor grain, the phosphor matrix is more readily excited to luminosity by low threshold voltage potentials. The flow of electron field described thusly is typical of other adjacent and non-adjacent parts of the phosphor screen structure, and can be considered as applicable throughout the structure according to the present invention.

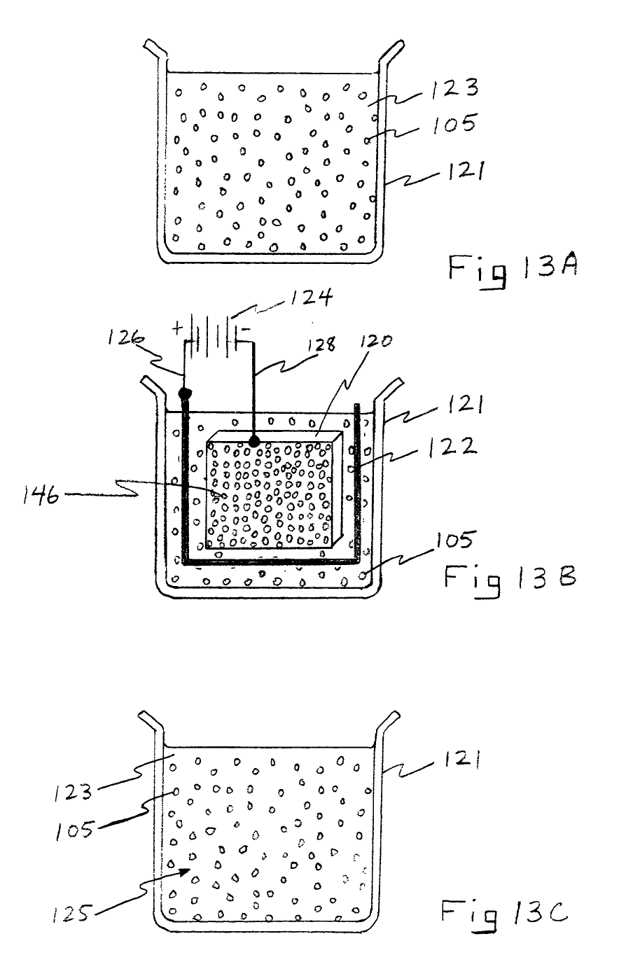

Representational drawings FIG. 13A through 13C depict phases for manufacture of phosphor screens. In accordance with the present invention, parts of the deposition system shown in FIGS. 13Aa through 13C include: a deposition vessel (121) that contains a uniformly homogenous deposition bath (123) and uniformly distributed suspended phosphor grains (105). The homogenous deposition bath (123) and vessel (121) is desirably maintained within an environment free of water and water vapor.

In FIG. 13A, uniformly distributed suspended phosphor grains (105) and bath (123) are in a state of readiness for the insertion of phosphor screen structure growth apparatus.

FIG. 13B depicts a phase of manufacture showing inserted phosphor screen structure growth apparatus including a cathode of the deposition system (120) attached via connection to the negative pole (128) of voltage source (124), and an anode (122) attached via connection to the positive pole (126) of voltage source (124). In accordance with the present invention, a uniformly deposited and distributed phosphor grain phosphor screen structure (146) is grown upon the cathode (120) of the apparatus that becomes the base foundation conductor surface (140) of FIG. 11.

In accordance with the present invention, FIG. 13C depicts deposition vessel (121) that contains a uniformly homogenous deposition bath (123) and uniformly distributed suspended phosphor grains (105) after the manufacturing phase depicted in FIG. 13B. In FIG. 13C, the zone (125) of deposition bath where cathode was located during the manufacturing phase of FIG. 13B is shown and depicts the continued homogeneity and uniform dispersion of the bath contents according to the present invention. The continued homogeneity and uniform dispersion of the bath contents is advantageous for control of the manufacturing quality and process of multiple screens through the phase in which the phosphor structure is grown. The appropriate higher viscosity provided by the solution and controlled mixture of the present invention provides continued homogeneity and continued suspension of phosphor particles within the deposition bath as multiple instances occur of the phase of manufacture wherein the phosphor screen structure is grown.

Repeated controlled use of the same deposition bath through multiple phosphor screen structure growth operations and units with enhanced control of the uniformity of the suspended and dissolved components of the bath is made possible by the proper higher viscosity mixture in accordance with the present invention. Monitoring of the components within this deposition bath and maintenance of the ratio of components is alleviated in the present invention by continued homogeneity of the deposition bath at substantially similar ratios of the components. Overall homogeneity and uniformity of the deposition bath is desirable simultaneous with sub-zones of chaotic swirling eddy fluid currents and motion of the bath components which are part of the process of growth of the phosphor screen structure. Furthermore, these phases of the manufacturing process according to the present invention do not produce toxic gasses such as chlorine found in the prior art.

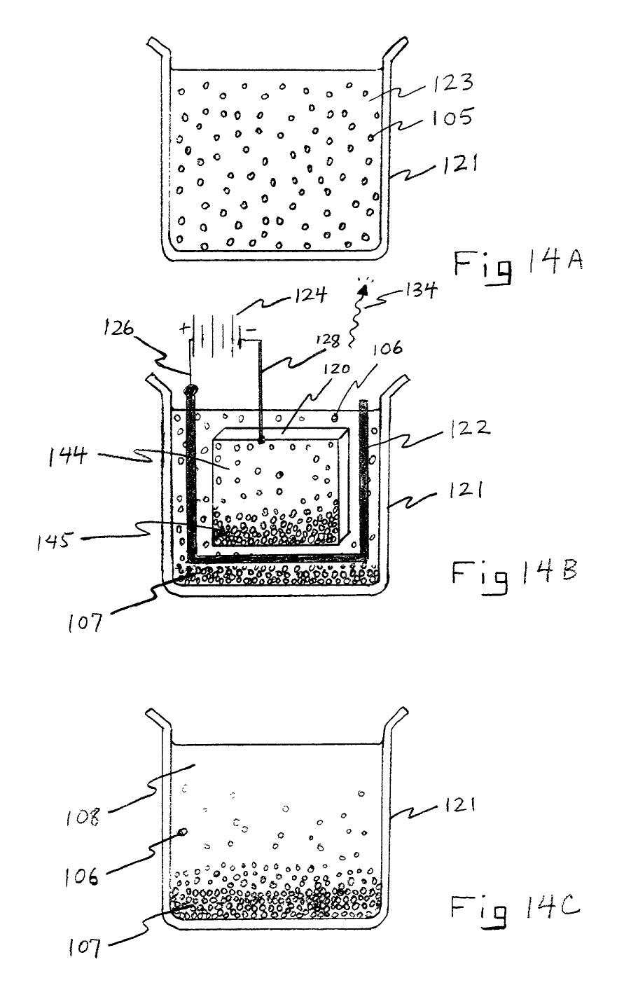

Representational drawings FIG. 14A through 14C depict phases for manufacture of phosphor screens such as those found in the prior art that lack well-controlled homogeneity and uniformity. FIG. 14A includes: a deposition vessel (121) that initially contains a uniformly homogenous deposition bath (123) and uniformly distributed suspended phosphor grains (105). The deposition bath of FIGS. 14B through 14C lacks homogeneity and uniformly suspended phosphor grains and varies in ratio of components in different sub-zones of the mixture from top to bottom and adjacent to the cathode and anode apparatus. Lack of complete homogeneous suspension of deposition bath components over time occurs in prior art deposition systems. Lack of complete solution of the charging agent or weight of discrete suspended particles in prior art deposition systems or low viscosity of the mixture causes the prior art deposition bath to be less controlled. Prior art methods to alleviate this problem have usually involved vigorous agitation of the deposition bath and or the apparatus. In FIG. 14B, without well-controlled homogeneity and suspension, areas of thinly or weakly deposited phosphor screen components (144) due to thinly suspended zones (106) of phosphor screen components occur on cathode (120) and densely deposited phosphor screen components (145) occur on cathode (120) due to proximity of densely settled zones (107) of phosphor screen components which drop from suspension. Also as depicted in FIG. 14B, prior art methods may produce undesirable or toxic gases (134) during the manufacture process such as chlorine.

The following examples are descriptive and illustrative of various methods used to build the typical phosphor structures in accordance with the present invention:

### EXAMPLE 1

One hundred grams of 3 mm Pyrex™ beads were placed in a 70 ml capacity ball mill. The following compounds were added to the ball mill: 17 ml of isopropyl alcohol (IPA), 3 ml of a 50:50 mixture of IPA and glycerol, 2 grams of ZnS:Cu,Au phosphor granules and 60 mg of indium nitrate (In(NO₃)₃). This combination was rolled in the ball mill for 1 hour.

After milling, the resultant slurry was separated from the glass beads and placed in a 400 ml beaker. The glass beads were rinsed with IPA three times, and the rinses were all added to the 400 ml beaker. IPA was then added to the beaker, to give a total volume of 250 ml, and the beaker was placed in a sonicator for 15 minutes.

After sonication, the phosphor screen structure was grown on an ITO-coated glass slide, using a solid electrode parallel to and 1.5 cm away from the slide. A constant potential of 50 V was maintained between the electrode and the glass slide for 90 seconds. The slide was removed from the bath and rinsed twice, first in IPA, then in acetone. The slide was allowed to air dry and was then baked in air at 425° C. for 30 minutes.

### EXAMPLE 2

One hundred grams of 3 mm Pyrex™ beads were placed in a 70 ml capacity ball mill. The following compounds were added to the ball mill: 17 ml of isopropyl alcohol (IPA), 3 ml of a 50:50 mixture of IPA and glycerol, 2 grams of ZnS:Cu,Al,Au phosphor granules, 60 mg of indium nitride (InN) and 60 mg of indium nitrate (In(NO₃)₃). This combination was rolled in the ball mill for 1 hour.

After milling, the resultant slurry was separated from the glass beads and placed in a 400 ml beaker. The glass beads were rinsed with IPA three times, and the rinses were all added to the 400 ml beaker. IPA was then added to the beaker, to give a total volume of 250 ml, and the beaker was placed in a sonicator for 15 minutes.

After sonication, the phosphor screen structure was grown on an ITO-coated glass slide, using a solid electrode parallel to and 1.5 cm away from the slide. A constant potential of 50 V was maintained between the electrode and the glass slide for four minutes. The slide was removed from the bath and rinsed twice, first in IPA, then in acetone. The slide was allowed to air dry and was then baked in air at 425° C. for 30 minutes.

### EXAMPLE 3

One hundred grams of 3 mm Pyrex™ beads were placed in a 70 ml capacity ball mill. The following compounds were added to the ball mill: 17 ml of isopropyl alcohol (IPA), 3 ml of a 50:50 mixture of IPA and glycerol, 2 grams of Y₂O₂S:Eu phosphor granules, 1 gram of reagent grade Indium oxide (In₂O₃) and 60 mg of indium nitrate (In(NO₃)). This combination was rolled in the ball mill for 2 hours.

After milling, the resultant slurry was separated from the glass beads and placed in a 400 ml beaker. The glass beads were rinsed with IPA three times, and the rinses were all added to the 400 ml beaker. IPA was then added to the beaker, to give a total volume of 250 ml, and the beaker was placed in a sonicator for 15 minutes.

After sonication, the phosphor screen structure was grown on an ITO-coated glass slide, using a solid electrode parallel to and 1.5 cm away from the slide. A constant potential of 50 V was maintained between the electrode and the glass slide for four minutes. The slide was removed from the bath and rinsed twice, first in IPA, then in acetone. The slide was allowed to air dry and was then baked in air at 425° C. for 60 minutes.

### EXAMPLE 4

A solution was made comprising: 1 gram of indium nitrate, 1 ml glycerol and 50 ml isopropyl alcohol. 6 ml of this solution were combined with 100 grams of 3 mm Pyrex beads, 2 grams of ZnO:Zn phosphor and 4 ml of a 50:50 mixture of isopropyl alcohol and glycerol. This mixture was then rolled in a ball mill for one hour.

After milling, the resultant slurry was separated from the glass beads and placed in a 400 ml beaker. The glass beads were rinsed with IPA three times, and the rinses were all added to the 400 ml beaker. IPA was then added to the beaker, to give a total volume of 250 ml, and the beaker was placed in a sonicator for 15 minutes.

After sonication, the phosphor screen structure was grown on an ITO-coated glass slide, using a solid electrode parallel to and 1.5 cm away from the slide. A constant potential of 50 V was maintained between the electrode and the glass slide used for deposition for a period of 1 minute. The slide was removed from the deposition bath and rinsed twice, first in IPA, then in acetone. The slides were allowed to air dry and were then baked in air at 425° C. for 30 minutes.

### EXAMPLE 5

A plating suspension was prepared in the same method as given in Example 4. Using this solution, ZnO:Zn phosphors as part of the phosphor screen structure were grown on an ITO coated slide using an anode placed 1.5 cm away from and parallel to the ITO coated slide. A potential of 100 V was maintained between the slides for a period of 3 minutes. The slide was then rinsed, dried and baked in the same manner as given in example 4.

### EXAMPLE 6

A solution was made comprising: 1 gram of indium nitrate, 1 ml glycerol and 50 ml isopropyl alcohol. 6 ml of this solution were combined with 100 grams of 3 mm Pyrex beads, 2 grams of ZnS:Ag,Cl phosphor and 4 ml of a 50:50 mixture of isopropyl alcohol and glycerol. This mixture was then rolled in a ball mill for one hour.

The glass beads were removed from the suspension and rinsed with IPA. The rinses were added to the suspension and IPA was added to bring the total volume to 250 ml. This mixture was then sonicated for a period of 15 minutes. An assembly, consisting of an ITO-coated glass slide and a solid electrode 1.5 cm away from and parallel to the ITO coating, was lowered into the mixture. Using the ITO as the cathode, a constant potential of 35 V was applied to the glass slide and the electrode for a period of one minute. The slide was removed from the phosphor structure deposition bath and rinsed in IPA and acetone. The slide was allowed to air dry and was then baked at 425 degrees centigrade for 30 minutes in air.

### EXAMPLE 7

A structure deposition bath was prepared as shown in example 6. Using this bath, a ZnS:Ag,Cl phosphor structure was grown on an ITO coated slide using an anode placed 1.5 cm away from and parallel to the ITO coated slide. A potential of 100 V was maintained between the slides for a period of 2 minutes. The slide was then rinsed, dried and baked in the same manner as given in example 6.

### EXAMPLE 8

A solution was made comprising: 1 gram of indium nitrate, 1 ml glycerol and 50 ml isopropyl alcohol. 6 ml of this solution were combined with 100 grams of 3 mm Pyrex beads, 2 grams of (Zn,Cd)S:Ag,Zn phosphor and 4 ml of a 50:50 mixture of isopropyl alcohol and glycerol. This mixture was then rolled in a ball mill for one hour.

The glass beads were removed from the suspension and rinsed with IPA. The rinses were added to the suspension and IPA was added to bring the total volume to 250 ml. This mixture was then ultrasonically agitated for a period of 15 minutes. An assembly, consisting of an ITO-coated glass slide and a solid electrode 1.5 cm away from and parallel to the ITO coating, was lowered into the mixture. Using the ITO conductive base foundation as the cathode, a constant potential of 50 V was applied to the ITO of the glass slide and the electrode for a period of two minutes. The slide was removed from the structure-growing bath and rinsed in IPA and acetone. The slide was allowed to air dry and was then baked at 425 degrees centigrade for 30 minutes in air.

While the preferred embodiment of the invention has been illustrated and described, many changes can be made without departing from the spirit and scope of the invention. Accordingly, the scope of the invention is not limited by the disclosure of the embodiment herein. Instead, the invention should be determined entirely by reference to the claims that follow.

1. A luminescent screen comprising:
a transparent substrate;
a transparent conductive layer covering said transparent substrate; and
a luminescent layer covering said transparent conductive layer, said luminescent layer comprising phosphor grains imbedded in and partially to fully covered by a conductive oxide layer.

2. The luminescent screen of claim 1 wherein the transparent insulating substrate comprises glass.

3. The luminescent screen of claim 1 wherein the transparent conductive layer is comprised of indium-tin oxide.

4. The luminescent screen of claim 1 wherein said transparent conductive layer is comprised of indium oxide.

5. The luminescent screen of claim 1, wherein said luminescent layer comprises luminescent particles adhered to said transparent conductive layer using indium oxide (In₂O₃).

6. A luminescent screen comprising:
a non-transparent substrate;
a non-transparent conductive layer covering said non-transparent substrate; and
a luminescent layer covering said non-transparent conductive layer, said luminescent layer comprising phosphor grains imbedded in and partially to fully covered by a conductive oxide layer.

7. The luminescent screen of claim 1 wherein the non-transparent insulating substrate comprises a silicon substrate.

8. The luminescent screen of claim 1 wherein the non-transparent conductive layer is comprised of aluminum.

9. A method of manufacture of a phosphor screen comprising:
a) mixing phosphor particles and indium nitrate in a non-aqueous solvent,
b) electrophoretically depositing the phosphors on a conductive surface, and
c) heat-treating the phosphor-coated assembly to produce a phosphor screen wherein each phosphor is embedded in and partially coated with indium oxide.

10. The method of claim 9 wherein said non-aqueous solvent is isopropyl alcohol.

11. The method of claim 9 wherein 1-10% by volume glycerol has been added to said non-aqueous solvent.

12. The method of claim 9 wherein indium oxide is co-deposited with said phosphor particles.

13. The method of claim 9 wherein indium nitride (InN) has been added to said deposition solution.

14. The method of claim 9 wherein said phosphor is chosen from the group of phosphors consisting of zinc oxide phosphors, zinc sulfide phosphors, zinc cadmium sulfide phosphors and rare earth phosphors.

15. A luminescent screen comprising:
a transparent insulating substrate;
a transparent conductive layer covering said transparent insulating substrate; and
a luminescent layer covering said transparent conductive layer, said luminescent layer comprising phosphor grains imbedded in and partially to fully covered by a conductive oxide layer; said phosphor grains being chosen from the group of phosphors consisting of zinc oxide phosphors, zinc sulfide phosphors, zinc cadmium sulfide phosphors and rare earth phosphors.

16. A luminescent screen comprising:
a transparent insulating substrate;
a transparent conductive layer covering said transparent insulating substrate; and a luminescent layer covering said transparent conductive layer, said luminescent layer comprising phosphor grains imbedded in and partially to fully covered by a conductive oxide layer, wherein solid indium oxide particles are mixed with said phosphor grains.

17. A luminescent screen comprising:
a non-transparent insulating substrate;
a non-transparent conductive layer covering said non-transparent insulating substrate; and
a luminescent layer covering said non-transparent conductive layer, said luminescent layer comprising phosphor grains imbedded in and partially to fully covered by a conductive oxide layer; said phosphor grains being chosen from the group of phosphors consisting of zinc oxide phosphors, zinc sulfide phosphors, zinc cadmium sulfide phosphors and rare earth phosphors.

18. A luminescent screen comprising:
a non-transparent insulating substrate;
a non-transparent conductive layer covering said non-transparent insulating substrate; and a luminescent layer covering said non-transparent conductive layer, said luminescent layer comprising phosphor grains imbedded in and partially to fully covered by a conductive oxide layer, wherein solid indium oxide particles are mixed with said phosphor grains.

19. A phosphor screen structure comprising:
a transparent substrate;
a transparent conductive layer covering said transparent substrate; and
a luminescent phosphor layer covering said transparent conductive layer, said luminescent layer comprising phosphor grains imbedded in and partially to fully covered by a conductive oxide layer.
